(19) United States
(12) Patent Application Publication
(10) Pub. No.: US 2020/0327503 A1
(43) Pub. Date: Oct. 15, 2020

(54) EMPLOYABILITY ASSESSOR AND PREDICTOR

(71) Applicant: ADP, LLC, ROSELAND, NJ (US)

(72) Inventors: Andre Mendes, Porto Alegre (BR); Roberto Dias, Sao Paulo (BR); Leandro Eidelwein, Porto Alegre (BR); Rafael Gomes, Porto Alegre (BR); Bruna Gouveia, Porto Alegre (BR); Eduardo Hoefel, Porto Alegre (BR); Roberto Silveira, Sao Paulo (BR)

(21) Appl. No.: 16/380,339

(22) Filed: Apr. 10, 2019

(51) Int. Cl. G06Q 10/10; G06Q 10/06; G06F 16/383; G06F 16/33; G06F 16/335; G06F 16/35; G06F 16/338; G06N 20/00

(52) U.S. Cl. CPC G06Q 10/1053; G06Q 10/063112; G06F 16/383; G06N 20/00; G06F 16/335; G06F 16/35; G06F 16/338; G06F 16/3334

(57) ABSTRACT

Aspects map, without association to job description data, candidate skills and activity data values to a metadata representation within a metadata repository; determine, without association to the job description data, via a machine learning process, a plurality of employability values for the candidate for top-trending jobs as a function of strength of match of the mapped activity and skills values to respective skills and activity data values that are associated within the repository to top-trending jobs without association to values of the job description data that are associated to the top trending jobs; generate a prioritized subset of the top trending jobs that omits jobs that have employability values failing to meet a minimum threshold employability value; and drive a graphical user interface display to present the prioritized subset of the top trending jobs to the candidate ranked as a function of their determined employability values.

### BACKGROUND

Human resource management (sometimes “HRM” or “HR”) generally refers to functions and systems deployed in organizations that are designed to facilitate or improve employee, member or participant performance in service of an organization or employer's strategic objectives. HR comprehends how people are identified, categorized and managed within organizations via a variety of policies and systems. Human Resource management systems may span different organization departments and units with distinguished activity responsibilities: examples include employee retention, recruitment, training and development, performance appraisal, managing pay and benefits, and observing and defining regulations arising from collective bargaining and governmental laws. Human Resource Information Systems (HRIS) comprehend information technology (IT) systems and processes configured and utilized in the service of HR, and HR data processing systems which integrate and manage information from a variety of different applications and databases.

### SUMMARY

In one aspect of the present invention, a method includes a processor mapping, without association to job description data, values of skills and activity data for a first candidate to a metadata representation of the first candidate that comprises a plurality of data dimensions stored within a metadata repository, wherein the metadata repository comprises skills and activity dimensional values for each of a plurality of candidates inclusive of the first candidate that are not associated to the job description data; determining, without association to the job description data, via a machine learning process, a plurality of employability values for the first candidate for each of a plurality of top-trending jobs, wherein the determining is a function of strength of match of the activity and skills values mapped for the first candidate to respective skills and activity data values within the repository that are associated to each of the top-trending subset of jobs without association to values of the job description data that are associated to the top trending jobs; filtering the top-trending jobs to generate a prioritized subset of the top trending jobs that omits ones of the top-trending jobs that have employability values that fail to meet a minimum threshold employability value; and driving a graphical user interface display to present the prioritized subset of the top trending jobs to the candidate ranked as a function of differences in their determined employability values.

In another aspect, a system has a hardware processor in circuit communication with a computer readable memory and a computer-readable storage medium having program instructions stored thereon. The processor executes the program instructions stored on the computer-readable storage medium via the computer readable memory and thereby map, without association to job description data, values of skills and activity data for a first candidate to a metadata representation of the first candidate that comprises a plurality of data dimensions stored within a metadata repository, wherein the metadata repository comprises skills and activity dimensional values for each of a plurality of candidates inclusive of the first candidate that are not associated to the job description data; determine, without association to the job description data, via a machine learning process, a plurality of employability values for the first candidate for each of a plurality of top-trending jobs, wherein the determining is a function of strength of match of the activity and skills values mapped for the first candidate to respective skills and activity data values within the repository that are associated to each of the top-trending subset of jobs without association to values of the job description data that are associated to the top trending jobs; filter the top-trending jobs to generate a prioritized subset of the top trending jobs that omits ones of the top-trending jobs that have employability values that fail to meet a minimum threshold employability value; and drive a graphical user interface display to present the prioritized subset of the top trending jobs to the candidate ranked as a function of differences in their determined employability values.

In another aspect, a computer program product has a computer-readable storage medium with computer readable program code embodied therewith. The computer readable program code includes instructions for execution which cause the processor to map, without association to job description data, values of skills and activity data for a first candidate to a metadata representation of the first candidate that comprises a plurality of data dimensions stored within a metadata repository, wherein the metadata repository comprises skills and activity dimensional values for each of a plurality of candidates inclusive of the first candidate that are not associated to the job description data; determine, without association to the job description data, via a machine learning process, a plurality of employability values for the first candidate for each of a plurality of top-trending jobs, wherein the determining is a function of strength of match of the activity and skills values mapped for the first candidate to respective skills and activity data values within the repository that are associated to each of the top-trending subset of jobs without association to values of the job description data that are associated to the top trending jobs; filter the top-trending jobs to generate a prioritized subset of the top trending jobs that omits ones of the top-trending jobs that have employability values that fail to meet a minimum threshold employability value; and drive a graphical user interface display to present the prioritized subset of the top trending jobs to the candidate ranked as a function of differences in their determined employability values.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method or process aspect according to an embodiment of the present invention.

FIG. 2 is a flow chart illustration of another method or process aspect according to an embodiment of the present invention.

### DETAILED DESCRIPTION

To identify or decide on career futures, including as whether to pivot professions, individuals typically rely upon their own knowledge of job markets; or on the opinions, perceptions, knowledge or advice of friends, family, business and social contacts or mentors; or on their intuitions (“gut feelings”). However, as professionals are primarily aware of their own candidacy experiences, and those of colleagues, co-workers, friends, family, etc., the limited scope of information used for such decisions frequently results in inaccurate market perceptions.

Candidates for career changes may acquire more in-depth market information from advanced training content and accruing additional work experience. However, such deeper knowledge and insight generally becomes fully developed and available for making career change decisions only after the candidate has committed significant time and resources within a career, wherein the best opportunities for change (those that present the best potential for new career development) may have already passed, or peaked, and wherein other opportunity frequencies or availabilities may actually decrease over elapsed time from the missed peak times.

Conventional HR employability assessment services or processes are generally limited in scope, in part from focusing data gathering and processing mostly on their own talent requirements. They may fail to offer consistent levels of service, quality or accuracy with respect to projecting future employment and salary opportunities across different technical fields for a given candidate due to inconsistencies in the quality of employment data or business intelligence acquired and processed across differing career areas. This is due in part to a tendency to primarily serve their own unique organizational objectives, costs, needs and services, causing their career development recommendation outputs to be limited in scope, including to specific, sometimes isolated domains (bubbles) within a greater universe of potential possibilities.

Conventional HR employability assessment services may also be tied to newer career paths, and thus, be overly focused on processing data acquired from new hires, resulting in projections that are inherently less reliable relative to those of more mature career paths that have more data acquired over longer timeframes (reflecting more comprehensive trends over a greater variety of economic contexts). Other career options may present less amounts of data to consider, for example, due to more limited public data availability, and the reliability the acquired data or knowledge may also vary across different career domains. Due to such data inequalities, conventional services may base employability assessments on insufficient, incorrect or untrustworthy data, wherein the risks of faulty projections are proportionate to the weight that such deficient data is considered in generating the projections. Therefore, conventional HR employability assessment services should not be relied upon to provide reliable, comprehensive career path recommendations tailored to the needs of a particular candidate.

While candidates may make career changes in reaction to contemporaneous discovery of new jobs or new demands, it is generally better to predict new jobs or demands that are appropriate for a given candidate in advance, by analyzing market trends and hiring and firing movements in the context of the unique candidate experience and employment posture, so that the candidate takes action at the appropriate time, and not too late, when the moment has passed or other candidates rush in to overwhelm limited opportunities.

Moreover, in order to avoid missing unknown but time-limited employment or career development opportunities, some candidates try to assess their own employability in a current market by actively engaging and participating in hiring processes (such as by using job placement agencies to offer their services on the employment market, going on hiring interviews and assessments, etc.). However, such candidates may not be ready or willing to move on from a current job and accept an offer for employment that arises from such resources, resulting in refusals of offers to change jobs. Such refusals may damage their reputation, as well as increase hiring costs for companies. Thus, frequencies of job offer refusals may proportionately decrease their worthiness for consideration as a new hire in the eyes of potential employers, and directly hinder their opportunities to move on to a better paying job or rewarding career path. This may pose great difficulty for someone trying to assess his or her own employability while looking for other opportunities in both similar and different career paths.

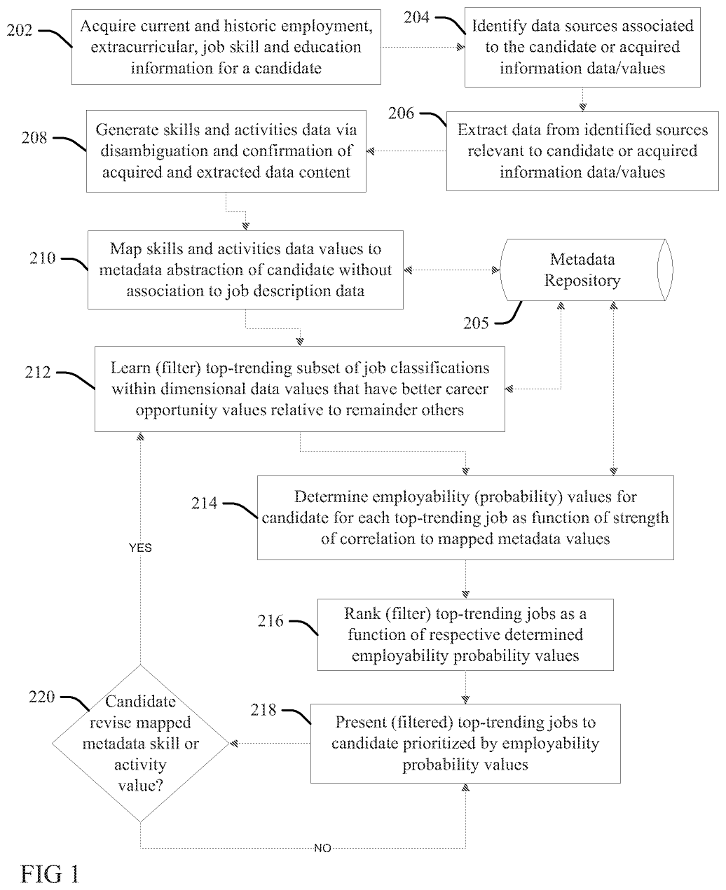

Aspects of the present invention provide advantages over conventional employability assessment services, processes and systems in solving the problems discussed above. FIG. 1 illustrates an employability assessor and predictor according to the present invention. At 202 a processor configured according to the present invention (the “configured processor”) acquires current and historic employment, extracurricular information data from activities details encompassing (or descriptive of) skill sets and past experiences that are developed rather than directly associated to positions occupied (for example, professional and social society and club membership and activities descriptors) and skills and education information (schools attended, degrees conferred, grade point averages, class rank, etc.) of a candidate (organization employee, prospective employee, intern, student, independent contractor, etc.). The configured processor may directly acquire the data at 202 in response to a question-and-answer form or template displayed or provided to the candidate, and still other acquisition means and techniques will be apparent to one skilled in the art.

At 204 the configured processor identifies data sources that are relevant or associated to the candidate or to the current and historic employment, extracurricular, job skills and education information data and values acquired at 202, and at 206 extracts additional data from the identified sources that is relevant or associated to the candidate or to the current and historic employment, extracurricular, job skills and education information data and values acquired at 202. A wide variety of data sources may be identified at 204, and the additional data extracted therefrom at 206, and illustrative but not exhaustive examples include:

(i.) Text content extracted via performing optical character recognition (OCR) processing on printed resume documents, cover letters, candidate application paperwork, extracurricular organization meeting and membership announcements, and other image information identified at 204 as relevant or associated to the candidate the data and values acquired at 202.

(ii.) Data extracted from social media services, such as joining extracurricular clubs or organizations or technology user groups, changes to marital status, domicile, residence, nationality, visa status, job, education or employer information, etc., that is extracted from postings by the candidate or social connections to Facebook®, Instagram®, LinkedIn® or other social and professional networking media services linked to the candidate at 204 (FACEBOOK and INSTAGRAM are trademarks of Facebook, Inc. in the United States or other countries; LINKEDIN is a trademark of LinkedIn Corp. in the United States or other countries).

For example, the configured processor may perform image analysis at 206 of a picture posted in a social media account of a friend of the candidate identified at 204 wherein the candidate is tagged and thereby determine (via comparison to labelled images, or fitting image data masques, etc.) that the candidate is wearing a graduation robe, which when considered in view of text content associated with the image processed via Natural Language Processing (NLP) techniques (“Big State University graduation, so proud!”) results in a determination that the candidate has likely earned additional education credentials, which further triggers a search for the name of the candidate within a publication of Big State University of the date of the metadata of the image or posting that lists the names of graduates and their awarded degrees and honors, which results in a determination that the candidate has earned a Masters of Science degree in Electrical Engineering with Honors from Big State University on said date.

In another example, the configured processor performs image analysis at 206 of a picture posted in a social media account of a friend of the candidate identified at 204 wherein the candidate is tagged and thereby determines (via comparison to labelled images, or fitting image data masques, etc.) that the candidate is a member of an extracurricular software programming club depicted within the image, which when considered in view of text content associated with the image processed via Natural Language Processing (NLP) techniques (“Big State University Hadoop Pros!”), results in a determination that the candidate has (likely) gained advanced Hadoop programing skills via participation in the club, which is confirmed (via increasing a confidence weighting) by verifying that the candidate is listed as a member of the club within club membership rolls.

(iii.) Data extracted from text content of standardized testing services, extracurricular activity newsfeeds, governmental records, credit report agency records, insurance company records, or other external public and/or private sources determined at 204 as relevant or associated to the candidate the data and values acquired at 202. For example, test scores of the candidate from Advanced Placement (AP), American College Testing (ACT), Scholastic Assessment Test (SAT), Graduate Record Examinations (GRE), Law School Aptitude test (LSAT), Medical College Admission Test (MCAT), Intelligence Quotient (IQ) or other standardized intelligence or proficiency tests may be retrieved from public or private records, including via obtaining consent from the candidate; the weather and climate data for residence, work and travel locations of the candidate; extracurricular or employment-related news and announcements, for example, announcement of a new club meeting location and data, or of construction of new headquarters in one location, or closure of offices in another location, projected numbers of new hires and club memberships and job or activity categories, etc.; and new regional tax locations, exemptions, visa programs, etc., within specific geographic regions identified at 204 as relevant or associated to the candidate or to the employment or extracurricular titles and data values of the candidate acquired at 202.

(iv.) Mobile device data: this is data and metadata extracted from the cell phone, tablet or other personal mobile programmable device of the candidate, including operating system and current and historic geolocation data.

At 208 the configured processor executes disambiguation and other data confirmation processes on the acquired and extracted text content data to generate (identify and/or define) employability skill and activity data attributes of the candidate that are implicit or explicit within the work, extracurricular and educational experience data of the candidate.

At 210 the configured processor maps or embeds the skill and activity data attributes (values) determined at 208 without association to job description data to a metadata abstraction or representation of the candidate stored (embedded) within a Metadata Repository 205. The mapping (embedding) at 210 generally de-normalizes the data information into a plurality of data dimensions that define a skills and activity meta representation (embedded instantiation) of the candidate, and further decouples the data from association to or dependence upon job description data. Mapping at 210 may transform a data element (salary, date of hire, club membership descriptor, etc.) that varies by data values, type or format across different employees, or organizations or departments, into a uniform, structured data of a specified or common value, data type or format.

Illustrative but not limiting or exhaustive examples of processes or systems applied at 210 include a include a Job Title Classifier that outputs a single, common job classification code “SOC (15-1133.00—Software Developers” for inputs of each of a plurality of different employee job titles or defined duties, skills or functions of the employees, including text string content derivative descriptions of “Hadoop engineer” and “Machine learning engineer,” etc., thereby resolving different input values to a same, common job title code. Further, an “Employee-type Clusterer” may identify type values for employee by finding commonalities across job title, duties, task, etc.: for example, a plurality of employees may be labeled (or assigned) an “Accounts receivable Services” type in response to determining that they each have duties that include the receipt and approval of payments from vendors or consumers. Still other examples will be apparent to one skilled in the art.

At 212 the configured processor, via a machine learning process, identifies determines, filters or otherwise learns a top-trending subset of a universe of job classifications that are defined (present) within the dimensional data values of the Metadata Repository 205 and that have best or better career opportunity values (salary, job title advancement opportunities, etc.) relative to other (remainder) ones of the job classifications defined (present) within the dimensional data values, as a function of current and historic employment data. For example, the configured processor includes “software architects”, “software engineer” and “Hadoop system manager” job titles into the trending subject at 212 in response to learning that they each have lower vacancy or employment rates, or have higher percentages of annual salary increase, relative to remainder job titles including “computer programmer,” “information technology analyst” and “Java® system technician” job titles (and wherein the configured processor responsively removes, drops or elides said remainder job titles from the trending subset, in the event they had been added to the trending subject in a previous iteration). (JAVA is a trademark of Oracle America, Inc., in the United States or other countries.)

In some embodiments, machine learning processes discussed herein comprehend executing multi-agent artificial intelligence (AI) processes comprising parallel executions of a plurality of deep-learning machine learning algorithms (for example, big-data preprocessing and classification, topic modeling, clustering, regression and classification, etc.) in order to cluster and categorize dimensional values associated to job descriptions that are relevant to salary and career opportunity values, and thereby associated to trending behavior of the top-trending jobs.

Thus, by filtering a universe of possible job descriptions into a “top-trending” subject grouping at 212, embodiments provide resource efficiencies over conventional systems, wherein only top-trending job opportunities are considered in determining employability assessments and predictions for the candidate as a function of the processes described below, rather than wasting resources on determining employability with respect to a job description that is not within this selective subject grouping, and by definition does not have good career or salary growth values in current market data represented within (or learned from) the repository 205 dimensional values relative to the selected, top-trending subset options.

At 214 the configured processor determines (predicts) employability (hiring) probability values for the candidate with respect to each of the top-trending jobs, as functions of machine learning process function outputs of strengths of correlation (clustering values, etc.) of the metadata abstraction representation skill and activity data attribute values mapped for the candidate within the repository 205 to the skill and activity data attributes of each of the “top-trending” subject grouping job descriptions, and wherein the determining the employability values is independent of (without association to) job description data of the top-trending jobs.

At 216 the configured processor ranks or filters, the “top-trending” job descriptions as a function of their respective employability probability values determined for the candidate.

At 218 the configured processor drives a graphical user interface (GUI) display to present the (filtered) “top-trending” job descriptions to the candidate prioritized (ranked) by their determined employability probability values.

In some embodiments, the ranking, filtering and presentment processes at 216 and 218 use a semaphore or analogous process that visually distinguishes the relative rankings by using differential color, font, formatting or other presentation technique. For example, at 218 a first grouping or clustering of one or more of the top-trending jobs having an 80% or higher employability (probability of hiring) value are depicted in a first presentation format (for example, a green-font statement or in association with a green icon, within a green table border or bracket, etc.), signifying preferred status, as more probable to result in a hire of the candidate relative to others of the top-trending jobs with lower values; a second grouping or clustering of the top-trending jobs having a probability of hiring between 40% and 79% are depicted in a second presentation format that is visually distinguished from the first presentation format (for example, in a yellow-font statement or in association with a yellow icon, within a yellow table border or bracket, etc.), signifying less preferred status than the first cluster (“green”) jobs, but still possible or more probable to result in a hire of the candidate relative to remaining others of the top-trending jobs with lower values; and a third grouping or clustering of the top-trending jobs having a probability of hiring lower than 40% are depicted in a third presentation format that is visually distinguished from the first and second presentation formats (for example, a red-font statement (or in association with a red icon, within a red table border or bracket, etc.), signifying that they are improbable to result in a hire of the candidate relative to the first and second (“green” and “yellow”) job clusters.

In some embodiments, the filtering process at 216 elides (drops, omits) the top-trending jobs having a probability of hiring lower than 40%, dropping them from the prioritized top-trending set presented to the candidate, but wherein the omitted jobs are distinctively displayed (in red, etc.) for informational purposes within the presentment at 218.

At 220 the configured processor provides a feedback and alternative scenario process, wherein in response to determining that the candidate has changed an embedded skill or attribute value, the configured processor returns to repeat the processes at 212, 214 and 216 to thereby iteratively present new job employability rankings and filtering of the top-trending jobs at 218 that are determined in response to the revised skill or attribute values.

For example, the presentation at 218 may include geographic locations of each of the top-trending jobs that correlate to a current residence of the candidate, wherein geographic location data is used in the machine learnings processes to learn the top-trending subset of job classifications that have better career opportunity values at 212 and to determine the employability values for a candidate for each of the top-trending jobs as a function of strength of correlation at 214. By changing the current (or projected, future) residence of the candidate from City A to City B within the embedded values at 220 to a different city, in response the presentment at 218 comprises a revised listing relative to the previous iteration. Thus, in a first iteration a top-trending “Python software programmer” job in City A is presented at 218 with a higher (green) employability probability value relative to a “Software architect” job in City A (presented in yellow). In response to changing this value to City B at 220, at 212 the configured processor learns a revised subset of top-trending jobs from changes to their respective career opportunity values based on strength of correlation to the new “City B” residence data; responsively determines new employability values for the candidate at 214 for each top-trending job as a function of strength of correlation to mapped metadata values inclusive of the new “City B” residence data; and thereby generates and presents the top-trending a “Software architect” job in City B with a higher (green) employability probability value relative to the “Python software programmer” job in City B (which is now presented in yellow) in a subsequent iteration of 218.

Thus, embodiments of the present invention determine employability probability values are based on comparing individual benchmark specific skills and attributes data of the job descriptions against the pre-processed embedded candidate data, rather than merely comparing job titles or descriptions to candidate work experience titles, as is common or required in conventional HR employability assessment services or processes. Embodiments thus enable a candidate to safely and virtually explore different scenarios and possibilities for changing jobs into currently open, top-trending job positions without risking harm to reputation, or perceptions of loyalty to a current employer, or unknowingly or unintentionally engaging in job search activities that in the real world may be subject to interpretation as a violation of an employment or termination agreement. For example, an engagement of a conventional hiring agency for services to assess employability may be interpreted as a positive action taken toward leaving a current position, or competing with a current or previous employer within a defined scope of employment during an agreed-upon exclusion term or within a designated geographic region.

Embodiments dynamically rank recent market positions for employability, determined by considering variable skills and attributes of the candidate at a deeper attribute level, instead of merely at the surface level of position names and titles as considered in the conventional processes and systems (and which are generally unresponsive to changing the individual skill and attribute values of the candidate). Embodiments present top-trending jobs ranked or filtered by employability values determinative of the best (most likely) fits for the skillsets and past experiences for each candidate that are independent of (agnostic to) different industry or background categories. Thus, embodiments enable a candidate to discover best-fitting jobs that are outside of their usual (limiting) industry descriptors and categories, and not necessarily within the scope of possibilities otherwise considered by the candidate.

Employability probabilities or values determined at 214 define objective values for correlation of the top-trending jobs to the candidate skill set, each reflecting strength of match to current candidate skills and likelihood that the candidate will be able to acquire any missing required skills, experience, etc. For example, while the candidate may have work experience and aptitude test scores that match some of the dimensions for a first of the top-trending job positions, the candidate may also need to acquire post-graduate educational credentials to switch from a current job to said first job that are unlikely to be obtained (below a minimum threshold of occurrence or correlation) for all candidates sharing (clustered by common) dimensional values of total years employed and ratio of combined salary and retirement income to residential debt service or monthly household expenses, etc. Accordingly, the employability value set or learned for the first job is generally lower that a value set for another (second) of the top-trending jobs for which any additional, missing requirements are more likely to be timely achieved by the candidate.

In some embodiments, the configured processor projects employability values for the candidate at 214 as a function of “digital twin” replicas of the candidate that are determined or projected from the candidate dimensional data values within the repository 205. A digital twin representation replicates both the candidate dimensional data values and estimations of how they will dynamically change over the future time periods as a function of predicted employment behaviors and life cycles: for example, new, revised or additional experiences or skills values that the candidate will likely acquire over the respective future time periods, identified and adjusted based on comparing and clustering the candidate dimensional data with other candidate data.

In some embodiments, digital twin replica values are determined for the candidate at 214 as a function of candidate clustering, including via Principal Component Analysis (PCA) or T-distributed Stochastic Neighbor Embedding (t-SNE) dimensionality reduction. Principal Component Analysis is a statistical procedure that uses an orthogonal transformation to convert a set of observations of possibly correlated variables (entities each of which takes on various numerical values) into a set of values of linearly uncorrelated variables called principal components. T-distributed Stochastic Neighbor Embedding is a nonlinear machine learning process that models each high-dimensional object by a two- or three-dimensional point in such a way that similar objects are modeled by nearby points and dissimilar objects are modeled by distant points with high probability.

Embodiments also project future employability values for the candidate at 214 as a function of clustering embedding processes, and illustrative but not limiting or exhaustive examples include “density-based spatial clustering of applications with noise” (DBSCAN), “k-nearest neighbors” (k-NN) and “ordering points to identify the clustering structure” (OPTICS) processes. DBSCAN is a density-based data clustering process wherein given a set of points in some space, DBSCAN groups together points that are closely packed together (points with many nearby neighbors), marking as outliers points that lie alone in low-density regions (whose nearest neighbors are too far away). OPTICS is a process for finding density-based clusters in spatial data that provides advantages over DBSCAN in detecting meaningful clusters in data of varying density, wherein points of a database are (linearly) ordered such that spatially closest points become neighbors in the ordering, and a special distance is stored for each point that represents the density that must be accepted for a cluster so that both points belong to the same cluster. The k-nearest neighbors (k-NN) process is a non-parametric pattern recognition method used for classification and regression: in both cases an input consists of the k-closest training examples in a feature space, wherein the output depends on whether the process is used for classification or regression. Still other clustering processes appropriate for practicing with the present invention will be apparent to one skilled in the art.

Conventional HR career planning services may fail to offer consistent levels of service, quality or accuracy with respect to projecting employability levels across different technical fields, in part due to inequalities in availability or quality of relevant employment data or business intelligence or across differing career areas. In contrast, via clustering values or recognizing other commonalities in geolocation dimensional data (for example, common geographic region, or within different geographic regions that share demographic similarities (percentages of college graduates with similar degree, or of candidates with similar job descriptions and salary ranges, etc.) that is extracted from candidate mobile phones or governmental reporting data (tax or visa filings, etc.), embodiments may determine confidence of match of a candidate to the skills, salaries, etc. of other candidates that have successfully transitioned to a new, selected top-trending job, wherein the shared dimensional value may bear no direct relation to credentials qualifying a candidate for the new job, and thereby go entirely unconsidered under conventional processes.

Conventional HR career planning systems and processes are generally costly in proportion to the number of candidates serviced or managed, resulting in larger costs for scaling-up to meet the needs of increased numbers of candidates. In contrast, aspects of the present invention provide advantages over conventional processes. The machine learning aspects of the embodiments described above learn associations of candidate skills data that might seem disparate or otherwise unrelated to other values present within other candidate dimensional data that is determined to be advantageous in securing new employment, salary raises, etc., in a rapid, autonomous fashion that conventional HR career planning systems would fail to recognize. By generating multi-class outputs that identify clustered data values associated with desirable, top-trending job classifications within dimensional data, aspects may rapidly and autonomously prioritize suggested or automated dimensional value recommendations and acquisitions (job experiences, educational specific, geographic locations or opportunities, etc.), to focus on the ones that provide the greatest likelihood of employability.

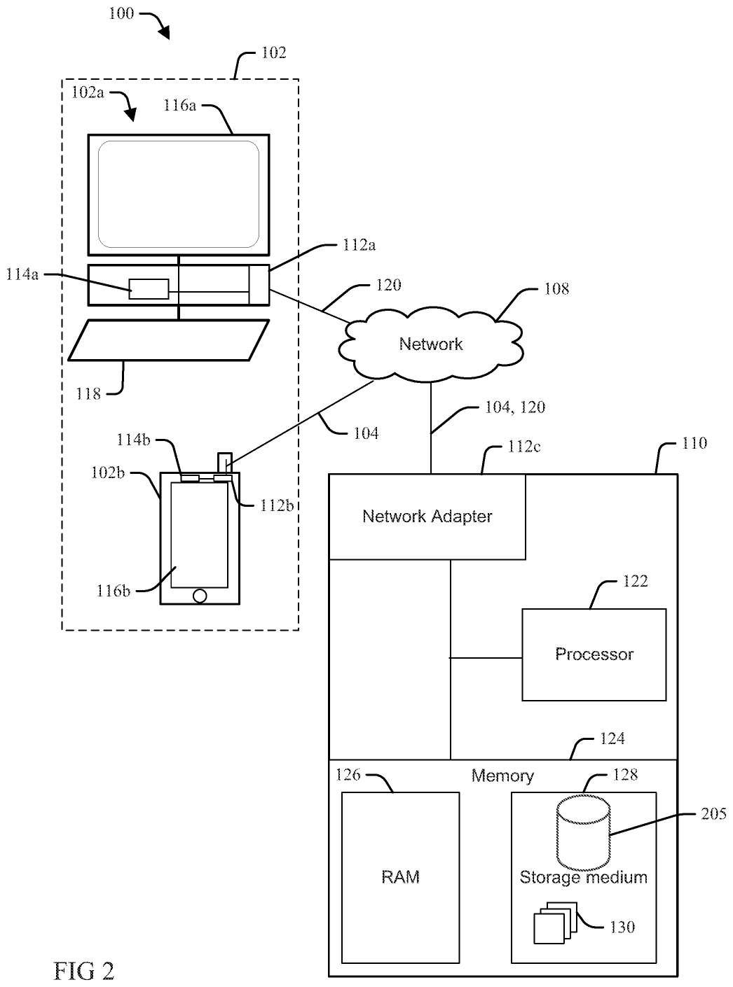

Moreover, the processes of learning top-trending subsets of job classifications within dimensional data values that have better salary or career opportunities relative to the remainder of others (at 212, FIG. 1) and presenting filtered rankings of top-trending jobs having the best (highest) employability values (at 218, FIG. 2) reduce dimensional data considered in an inherent, or overt, filtering process, and embodiments thereby provide computer system data processing and other cost efficiency advantages over conventional HR career planning systems and processes.

Aspects of the present invention include systems, methods and computer program products that implement the examples described above. A computer program product may include a computer-readable hardware storage device medium (or media) having computer-readable program instructions thereon for causing a processor to carry out aspects of the present invention.

FIG. 2 is a schematic, graphic illustration of an embodiment of a system 100 for autonomous employability determination processes pursuant to a process or system of FIG. 1. The system 100 includes one or more local computing devices 102, such as, for example, a desktop computer 102a or smartphone 102b, or a laptop computer, personal digital assistant, tablet, cellular telephone, body worn device, or the like. Lines of the schematic illustrate communication paths between the devices 102a, 102b and a computer server 110 over a network 108, and between respective components within each device. Communication paths between the local computing devices 102a and 102b and the computer server 110 over the network 108 include respective network interface devices 112a, 112b, and 112c within each device, such as a network adapter, network interface card, wireless network adapter, and the like.

In the present example, the smartphone 102b transfers (provides) candidate skills and activity data 104 (such as input by the candidate through a GUI display device 116b) over a network 108 to a computer server 110 via their respective network interface adapters 112b and 112c. The computer server 110 includes a processor 122 configured (thus, the “configured processor” discussed above with respect to FIGS. 1 and 2) with instructions stored in a memory 124. The processor 122 of the computer server 110 and the processors 114a and 114b of the local computing devices include, for example, a digital processor, an electrical processor, an optical processor, a microprocessor, a single core processor, a multi-core processor, distributed processors, parallel processors, clustered processors, combinations thereof and the like. The memory 124 includes a computer readable memory 126 and a computer readable storage medium 128.

The computer server 110, in response to receiving the candidate data 104, interacts with or updates the skills dimension data stored in the repository 205 in the various processes described above with respect to FIG. 1, including exporting generated data 120 over the network 108 to the local computing device 102a via their respective network interface adapters 112c and 112a. The local computing devices 102 include one or more input devices 118, such as a keyboard, mouse, microphone, touch screen, etc., and wherein the processor 114a drive display devices 116a to present the top-trending jobs prioritized or filtered as a function of their respective employability values as described above with respect to FIG. 1 element 218.

The computer readable storage medium 128 can be a tangible device that retains and stores instructions for use by an instruction execution device, such as the processor 122. The computer readable storage medium 128 may be, for example, but is not limited to, an electronic storage device, a magnetic storage device, an optical storage device, an electromagnetic storage device, a semiconductor storage device, or any suitable combination of the foregoing. A computer readable storage medium 128, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be transmitted to respective computing/processing devices from the computer readable storage medium 128 or to an external computer or external storage device via the network 108. The network 108 can include private networks, public networks, wired networks, wireless networks, data networks, cellular networks, local area networks, wide area networks, the Internet, and combinations thereof. The network interface devices 112a, 112b and 122c in each device exchange (receive and send) computer readable program instructions from and through the network 108 and, including for storage in or retrieval from the computer readable storage medium 128.

Computer readable program instructions for carrying out operations of the present invention may include assembler instructions, instruction-set-architecture (ISA) instructions, machine instructions, machine dependent instructions, microcode, firmware instructions, state-setting data, configuration data for integrated circuitry, compiled or interpreted instructions, source code or object code written in any combination of one or more programming languages or programming environments, such as JAVA, Javascript®, C, C#, C++, Python, Cython, F#, PHP, HTML, Ruby, and the like. (JAVASCRIPT is a trademark of Oracle America, Inc., in the United States or other countries.)

The computer readable program instructions may execute entirely on the computer server 110, partly on the computer server 110, as a stand-alone software package, partly on the computer server 110 and partly on the local computing devices 102 or entirely on the local computing devices 102. For example, the local computing devices 102 can include a web browser that executes HTML instructions transmitted from the computer server 110, and the computer server executes JAVA instructions that construct the HTML instructions. In another example, the local computing devices 102 include a smartphone application, which includes computer readable program instructions to perform the processes described above.

The memory 124 can include a variety of computer system readable media. Such media may be any available media that is accessible by computer server 110, and the media includes volatile media, non-volatile media, removable, non-removable media, and combinations thereof. Examples of the volatile media can include random access memory (RAM) and/or cache memory. Examples of non-volatile memory include magnetic disk storage, optical storage, solid state storage, and the like. As will be further depicted and described below, the memory 124 can include at least one program product having a set (e.g., at least one) of program modules 130 that are configured to carry out the functions of embodiments of the invention.

The computer system 100 is operational with numerous other computing system environments or configurations. Examples of well-known computing systems, environments, and/or configurations that may be suitable for use with computer system 100 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine (“a configured processor”), such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one aspect, a service provider may perform process steps of the invention on a subscription, advertising, and/or fee basis. That is, a service provider could offer to integrate computer-readable program code into the computer system 100 to enable the computer system 100 to perform the processes of FIG. 1 discussed above. The service provider can create, maintain, and support, etc., a computer infrastructure, such as components of the computer system 100, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 110, from a tangible computer-readable medium device 128; (2) adding one or more computing devices to the computer infrastructure 100; and (3) incorporating and/or modifying one or more existing systems 110 of the computer infrastructure 100 to enable the computer infrastructure 100 to perform process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty and are not to be construed to limit the claims to any specific illustrated element or embodiment, or to imply any precedence, ordering or ranking of any claim elements, limitations or process steps.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
mapping, without association to job description data, values of skills and activity data for a first candidate to a metadata representation of the first candidate that comprises a plurality of data dimensions stored within a metadata repository, wherein the metadata repository comprises skills and activity dimensional values for each of a plurality of candidates inclusive of the first candidate that are not associated to the job description data;
determining, without association to the job description data, via a machine learning process, a plurality of employability values for the first candidate for each of a plurality of top-trending jobs, wherein the determining is a function of strength of match of the activity and skills values mapped for the first candidate to respective skills and activity data values within the repository that are associated to each of the top-trending subset of jobs without association to values of the job description data that are associated to the top trending jobs;
filtering the top-trending jobs to generate a prioritized subset of the top trending jobs that omits ones of the top-trending jobs that have employability values that fail to meet a minimum threshold employability value; and
driving a graphical user interface display to present the prioritized subset of the top trending jobs to the candidate ranked as a function of differences in their determined employability values.

2. The method of claim 1, wherein the driving the graphical user interface display to present the ranked prioritized subset of the top trending jobs comprises:
depicting a first job of the ranked prioritized subset of the top-trending jobs in a first visual presentation format in response to determining that the employability value of said first job meets a high probability of hiring threshold; and
depicting a second job of the ranked prioritized subset of the top-trending jobs in a second visual presentation format in response to determining that the employability value of said second job does not meet the high probability of hiring threshold, wherein the second visual presentation format is visually distinguished from the first presentation format.

3. The method of claim 2, wherein the driving the graphical user interface display to present the ranked prioritized subset of the top trending jobs comprises:
depicting a third job of the top-trending jobs that was omitted from the prioritized subset of the top trending jobs for having an employability value that failed to meet the minimum threshold employability value in a third visual presentation format, wherein the third visual presentation format is visually distinguished from the first and second presentation formats.

4. The method of claim 1, further comprising:
generating, via a machine learning filtering process, the plurality of top-trending jobs as a subset of a larger plurality of a universe of job classifications that are each defined within dimensional data values of the metadata repository, wherein the generating is a function of determining from employment data that the top-trending jobs have better career opportunity values relative to the remainder of other ones of the universe of job classifications.

5. The method of claim 4, wherein the data dimensions stored the metadata repository for the first candidate metadata representation and the universe of job classifications comprise geographic location values, the method further comprising;
associating the career opportunity values of the universe of job classifications with geographic locations;
generating via the machine learning filtering process the subset of the top-trending jobs to comprise jobs having geographic locations matching the geographic location of the first candidate metadata representation; and
determining without association to job description data via the machine learning filtering process the plurality of employability values for the first candidate for each of the top-trending jobs as a function of strength of match of the geographic location of the first candidate metadata representation to the geographic locations of the top-trending jobs.

6. The method of claim 1, further comprising determining the employability values as a function of:
strengths of match of the skills and activity dimensional values mapped for the first candidate within the repository to skills and activity dimension values of the each of the top-trending subset job classifications; and
likelihoods that the candidate will be able to acquire any missing skills required for each of the top-trending subset job classifications as a function of current dimensional values mapped for the first candidate within the repository.

7. The method of claim 1, wherein the determining the employability values comprises:
projecting a digital twin replica of the skills and activity dimensional values mapped for the first candidate within the repository at an end of the future time period as a function of a dimensional reduction of a subset of the dimensional data of the first candidate that is clustered with other candidate dimensional data within the repository.

8. The method of claim 7, wherein the dimensional reduction is a process selected from the group consisting of principal component analysis, T-distributed stochastic neighbor embedding, density-based spatial clustering of applications with noise and ordering points to identify a clustering structure.

9. The method of claim 1, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the mapping the values of skills and activity data for the first candidate to the metadata representation of the first candidate, the determining the employability values for the first candidate for each of the top-trending jobs, the filtering the top-trending jobs to generate the prioritized subset of the top trending jobs, and the driving the graphical user interface display to present the ranked, prioritized subset of the top trending jobs to the candidate.

10. The method of claim 9, wherein the computer-readable program code is provided as a service in a cloud environment.

11. A system, comprising:
a processor;
a computer readable memory in circuit communication with the processor; and
a computer readable storage medium in circuit communication with the processor; and
wherein the processor executes program instructions stored on the computer-readable storage medium via the computer readable memory and thereby:
maps, without association to job description data, values of skills and activity data for a first candidate to a metadata representation of the first candidate that comprises a plurality of data dimensions stored within a metadata repository, wherein the metadata repository comprises skills and activity dimensional values for each of a plurality of candidates inclusive of the first candidate that are not associated to the job description data;
determines, without association to the job description data, via a machine learning process, a plurality of employability values for the first candidate for each of a plurality of top-trending jobs, wherein the determining is a function of strength of match of the activity and skills values mapped for the first candidate to respective skills and activity data values within the repository that are associated to each of the top-trending subset of jobs without association to values of the job description data that are associated to the top trending jobs;
filters the top-trending jobs to generate a prioritized subset of the top trending jobs that omits ones of the top-trending jobs that have employability values that fail to meet a minimum threshold employability value; and
drives a graphical user interface display to present the prioritized subset of the top trending jobs to the candidate ranked as a function of differences in their determined employability values.

12. The system of claim 11, wherein the processor executes the program instructions stored on the computer-readable storage medium via the computer readable memory and thereby drives the graphical user interface display to present the ranked prioritized subset of the top trending jobs by:
depicting a first job of the ranked prioritized subset of the top-trending jobs in a first visual presentation format in response to determining that the employability value of said first job meets a high probability of hiring threshold; and
depicting a second job of the ranked prioritized subset of the top-trending jobs in a second visual presentation format in response to determining that the employability value of said second job does not meet the high probability of hiring threshold, wherein the second visual presentation format is visually distinguished from the first presentation format.

13. The system of claim 12, wherein the processor executes the program instructions stored on the computer-readable storage medium via the computer readable memory and thereby drives the graphical user interface display to present the ranked prioritized subset of the top trending jobs by:
depicting a third job of the top-trending jobs that was omitted from the prioritized subset of the top trending jobs for having an employability value that failed to meet the minimum threshold employability value in a third visual presentation format, wherein the third visual presentation format is visually distinguished from the first and second presentation formats.

14. The system of claim 11, wherein the processor executes the program instructions stored on the computer-readable storage medium via the computer readable memory and thereby:
generates, via a machine learning filtering process, the plurality of top-trending jobs as a subset of a larger plurality of a universe of job classifications that are each defined within dimensional data values of the metadata repository, wherein the generating is a function of determining from employment data that the top-trending jobs have better career opportunity values relative to remainder other ones of the universe of job classifications.

15. The system of claim 14, wherein the data dimensions stored the metadata repository for the first candidate metadata representation and the universe of job classifications comprise geographic location values, and wherein the processor executes the program instructions stored on the computer-readable storage medium via the computer readable memory and thereby:
associates the career opportunity values of the universe of job classifications with geographic locations;
generates via the machine learning filtering process the subset of the top-trending jobs to comprise jobs having geographic locations matching the geographic location of the first candidate metadata representation; and
determines without association to job description data via the machine learning filtering process the plurality of employability values for the first candidate for each of the top-trending jobs as a function of strength of match of the geographic location of the first candidate metadata representation to the geographic locations of the top-trending jobs.

16. The system of claim 11, wherein the processor executes the program instructions stored on the computer-readable storage medium via the computer readable memory and thereby determines the employability values as a function of:
strengths of match of the skills and activity dimensional values mapped for the first candidate within the repository to skills and activity dimension values of the each of the top-trending subset job classifications; and
likelihoods that the candidate will be able to acquire any missing skills required for each of the top-trending subset job classifications as a function of current dimensional values mapped for the first candidate within the repository.

17. The system of claim 11, wherein the processor executes the program instructions stored on the computer-readable storage medium via the computer readable memory and thereby determines the employability values by:
projecting a digital twin replica of the skills and activity dimensional values mapped for the first candidate within the repository at an end of the future time period as a function of a dimensional reduction of a subset of the dimensional data of the first candidate that is clustered with other candidate dimensional data within the repository; and
wherein the dimensional reduction is a process selected from the group consisting of principal component analysis, T-distributed stochastic neighbor embedding, density-based spatial clustering of applications with noise and ordering points to identify a clustering structure.

18. A computer program product, comprising:
a computer readable storage medium having computer readable program code embodied therewith, wherein the computer readable storage medium is not a transitory signal per se, the computer readable program code comprising instructions for execution by a processor that cause the processor to:
map, without association to job description data, values of skills and activity data for a first candidate to a metadata representation of the first candidate that comprises a plurality of data dimensions stored within a metadata repository, wherein the metadata repository comprises skills and activity dimensional values for each of a plurality of candidates inclusive of the first candidate that are not associated to the job description data;
determine, without association to the job description data, via a machine learning process, a plurality of employability values for the first candidate for each of a plurality of top-trending jobs, wherein the determining is a function of strength of match of the activity and skills values mapped for the first candidate to respective skills and activity data values within the repository that are associated to each of the top-trending subset of jobs without association to values of the job description data that are associated to the top trending jobs;
filter the top-trending jobs to generate a prioritized subset of the top trending jobs that omits ones of the top-trending jobs that have employability values that fail to meet a minimum threshold employability value; and
drive a graphical user interface display to present the prioritized subset of the top trending jobs to the candidate ranked as a function of differences in their determined employability values.

19. The computer program product of claim 18, wherein the computer readable program code instructions for execution by the processor further cause the processor to drive the graphical user interface display to present the ranked prioritized subset of the top trending jobs by:
depicting a first job of the ranked prioritized subset of the top-trending jobs in a first visual presentation format in response to determining that the employability value of said first job meets a high probability of hiring threshold; and
depicting a second job of the ranked prioritized subset of the top-trending jobs in a second visual presentation format in response to determining that the employability value of said second job does not meet the high probability of hiring threshold, wherein the second visual presentation format is visually distinguished from the first presentation format.

20. The computer program product of claim 18, wherein the computer readable program code instructions for execution by the processor further cause the processor to determine the employability values as a function of:
strengths of match of the skills and activity dimensional values mapped for the first candidate within the repository to skills and activity dimension values of the each of the top-trending subset job classifications; and
likelihoods that the candidate will be able to acquire any missing skills required for each of the top-trending subset job classifications as a function of current dimensional values mapped for the first candidate within the repository.
